(19) United States
(12) Patent Application Publication
(10) Pub. No.: US 2018/0262548 A1
(43) Pub. Date: Sep. 13, 2018

(54) Method for Viewing On-Line Content

(71) Applicant: Delmond Newton, Philadelphia, PA (US)

(72) Inventor: Delmond Newton, Philadelphia, PA (US)

(21) Appl. No.: 15/915,471

(22) Filed: Mar. 8, 2018

Related U.S. Application Data
(60) Provisional application No. 62/468,588, filed on Mar. 8, 2017.

(51) Int. Cl. H04L 29/06; H04N 7/14

(52) U.S. Cl. CPC H04L 65/60; H04L 65/1066; H04L 65/403; H04N 7/147

(57) ABSTRACT

A method for viewing on-line content includes providing on-line content on a remote server and selecting on-line content to be viewed, as well as a time for viewing the on-line content in a group session. A host invites other individuals to simultaneously view the content. Each invitee can accept or reject the invitation. A notification is provided to the host as to whether each invitee has accepted or rejected the invitation. The host and invitees can then collectively view the on-line content beginning at the selected time.

### CROSS-REFERENCE TO RELATED APPLICATION

The present application claims the priority of U.S. Provisional Application No. 62/468,588, filed Mar. 8, 2017, which is incorporated by reference in its entirety herein.

### BACKGROUND OF THE INVENTION

Social media, such as Facebook, Twitter, and Instagram, in many forms has transformed the day-to-day lives of a multitude of individuals. The increasing popularity of social media has been criticized for tending to isolate individual users from actual real-time contact with other individuals. Thus, there is a need for improved forms of social media, and especially entertainment, which tend to enhance actual real-time contact among users of the media.

### SUMMARY OF THE INVENTION

The present invention provides an improved method for viewing on-line content. The method comprises providing on-line content on a remote server; selecting on-line content to be viewed on the remote server; selecting a time for viewing the on-line content in a group session; inviting at least one individual to view the on-line content; the at least one individual accepting or rejecting the invitation; providing a notification that the at least one individual has accepted or rejected the invitation; viewing the on-line content beginning at the selected time. Preferably, the on-line content is transcoded for simultaneous streaming. Preferably, the method further comprises uploading the on-line content to the remote server. Preferably, the method further comprises maintaining the on-line content in a library on the remote server for a limited time. Preferably, the on-line content is video. Preferably, the method further comprises providing video chat capability to each of the individuals viewing the on-line content, the video chat capability enabling each of the individuals to communicate with one another. Preferably, the on-line content is selected using an application adapted to communicate with the remote server. Preferably, the method further comprises creating the on-line content.

### BRIEF DESCRIPTION OF THE DRAWINGS

FIG. 1 is a schematic illustration of a display device of a host user such as a smart phone showing an initial step in the method of the present invention.

FIG. 2 is a schematic illustration of the display device of FIG. 1 showing a subsequent step in the method of the present invention.

FIG. 3 is a schematic illustration of a display device of an invited user such as a smart phone showing a subsequent step in the method of the present invention.

FIG. 4 is a schematic illustration of the display device of FIG. 1 showing a subsequent step in the method of the present invention.

FIG. 5 is a schematic illustration of the display device of FIG. 1 showing a subsequent step in the method of the present invention.

FIG. 6 is a schematic illustration of the display device of FIG. 3 showing a subsequent step in the method of the present invention.

FIG. 7 is a schematic illustration of the display device of FIG. 1 showing a subsequent step in the method of the present invention.

### DETAILED DESCRIPTION

The present invention provides a platform and method for enhanced actual real-time contact between users of social media. In the method of the present invention, an individual user or host can select one or more additional individuals to invite to simultaneously access on-line content, such as entertainment videos, live sporting events, and the like. The selected additional individuals can opt to accept or decline the host's invitation.

In one aspect, the invitations are extended at a time before the on-line content is presented, as in the case of live programming such as concerts or live sports. In another aspect, the invitations are extended when the content is being presented. In yet another aspect, the invitations are extended for a future time chosen by the host, as when the content is provided as on-demand content.

In one aspect, each of the invitees who has accepted the invitation is connected to the host immediately, or, in another aspect, shortly before the time established in the invitation. In one aspect, the nature of the connection is such that the host and each of the invitees can communicate with one another in real-time while viewing or listening to the content. Thus, the method emulates the host and the invitees viewing or listening to the content as a group physically assembled together. For example, the method can simulate a group of friends attending a music concert together, or viewing a feature film in a conventional movie theatre. In another aspect, the host uploads content, such as a video, to a remote server for subsequent viewing by the group.

The real-time communication among the host and invitees can take several forms. In one presently preferred embodiment, the method provides a real time image of each of the members of the group to each of the other members, and a simultaneous audio link among each of the members of the group, such that each of the members of the group can comment on the content being simultaneously accessed by the group.

In one presently preferred aspect of the invention, the host can invite up to three individuals to join in a group viewing session.

The method can be implemented on a variety of communication devices, such as personal computers, laptop computers, tablet computers such as Apple's iPad, and cell phones such as IOS or Android smart phones. For example, when implemented on a smart phone, an image of the content being viewed by the group can be overlaid with a window in which an image of each of the members of the group appears.

In one aspect, the host controls each aspect of the joint viewing session, including selection of the content to be shared by the group, the nature of the communication with each member of the group, and the like. Thus, in this aspect, the method provides for the host initiating and terminating the session, and adding, deleting, and/or blocking each of the invitees to the group viewing session.

In one aspect, each of the invitees can offer comments, including suggestions for content to be viewed, such as by texting, or in an audio mode.

In one aspect of the invention, the method is implemented on a server remote from the host and the invitees. In this aspect of the invention, the host and each of the invitees downloads a dedicated application from the remote server, the dedicated application being adapted to interact with the remote server.

In another aspect, an application specifically adapted for the host is downloaded as are applications specifically adapted for the invitees. Preferably, the downloaded application can be used to permit any of the users to act as host, or as invitee. Preferably, software on the remote server adapts the content for simultaneous viewing by the group, such as, for example, by optimizing the content for streaming, such as by transcoding. Preferably, the optimized content is stored on the remote server, preferably, for at least three days.

Thus, the present method provides a cohesive group viewing experience that preferably allows a host user the ability to invite at least three additional users to watch a video onscreen simultaneously. Preferably, the host user controls the full viewing experience. Preferably, the host user sends out an invite to the additional users, and once that invited user accepts, then the host and users will appear on screen together. Preferably, all have the ability to communicate via messaging and even talking. Preferably, posting comments and even suggesting videos to watch together is enabled by the method. Preferably, at any time the host can end the viewing experience, delete, block or add users to view with him/her.

For example, in one presently preferred embodiment of the method of the present invention, a user initially downloads a dedicated application from a remote server implementing the method of the present invention. The user then registers with the remote server and creates a user name. This user name can be shared with other users of the present method and optionally stored locally in the user's contacts. Once a user is registered, that user can upload content such as videos.

In one aspect of the present method, the uploaded content is no longer than five minutes in duration.

After a user uploads content, such as a video, the content is prepared on the remote server for optimized streaming, such as by transcoding. Once transcoding is complete, the video is stored in a library on the remote server for a limited amount of time, for example, up to three days.

The user, who will be the designated host, can then send an invitation to up to three other users to watch the uploaded video with them in real-time. The invitations are preferably sent using the user name created during the sign-up process.

Each of the invitees will then receive a notification, preferably including a unique alert sound, that they have been invited to view content with the host user using the present method.

Each invited user must accept the invitation in order to join the joint viewing session. If an invited user does not accept the invitation right away, the non-accepted invitation will preferably be logged in on the remote server as a missed invitation.

When the time designated for the group viewing session has passed, the invitation will preferably be designated as an in-progress invitation, and the invited user can join anytime while the session is in progress. Once the group viewing session has ended, the invitation will preferably be designated as expired.

The host user can preferably block other users from sending requests by making the other users' sessions public or private. Preferably, the host user can at any time control the on-line viewing session by fast-forwarding the content, rewinding the content, pausing the content, resuming play of the content, or otherwise controlling how the on-line content is displayed to the group of users viewing the content during the session, as well as preferably controlling the participation of each of the other users in the viewing session. Preferably, each of the users can video-chat and watch the content in real time. Once the content is over, the host can preferably terminate the session or choose additional content to initiate another session.

In one presently preferred embodiment, the on-line content is displayed during the session on each of the user's devices for monitoring the content, such as smart phones, with insets corresponding to each of the users appearing overlaid on the content, each inset displaying a real-time image of each of the users as they each view the content.

An implementation of a presently preferred embodiment of the method of the present invention is illustrated in the Figures, in which the reference numerals represent the same elements in each of the several views.

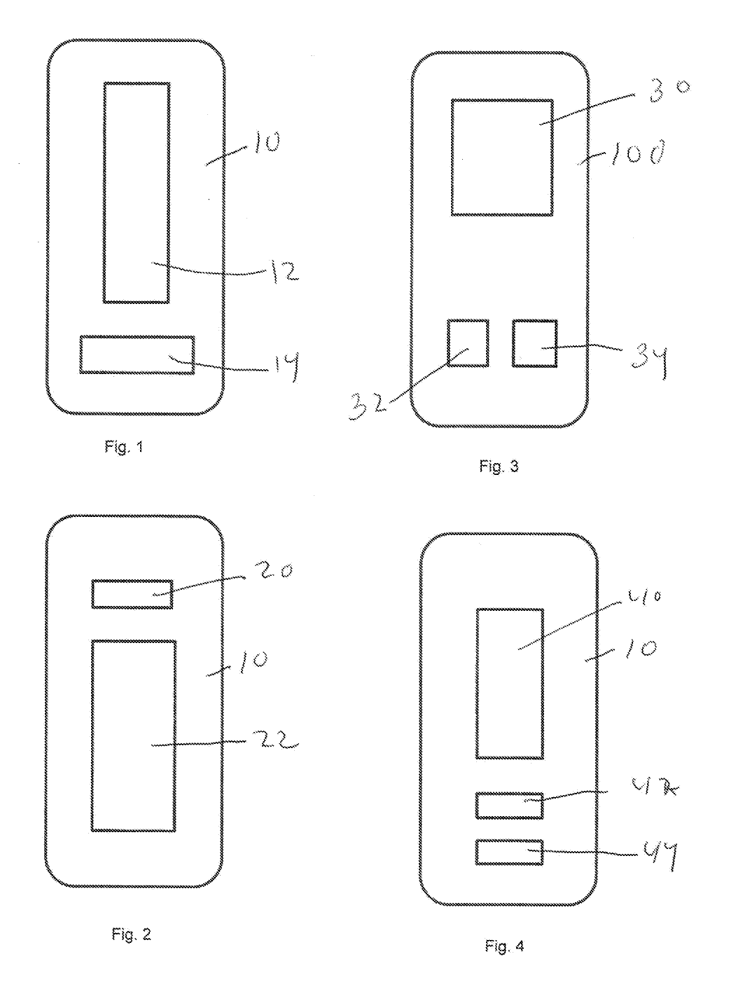

As illustrated in FIG. 1, the method is initiated by a host user by selecting an application resident on his or her display device, such as a smart phone 10, the application having been previously downloaded from a remote server, and the desired content having been previously selected. In the initial step, the host user chooses one or more individuals appearing on his or her contact list 12. As each individual is chosen, an indication such as a head shot appears in a selection area 14. In the next step of the method, the host user selects the time at which to initiate the content viewing session.

As shown in FIG. 2, the host user has the option of starting the session immediately by touching an immediate selection area 20 on the smart phone 10, or selecting a future time by scrolling through a start time display area 22 and selecting the desired time.

As shown in FIG. 3, each invited user is then provided a notification on his or her respective display device 100, on which appears a notification area 30 providing information about the session initiated by the host user, and providing an accept area 32 and a decline area 34 on the display device 100 enabling the invited user to accept or decline the invitation to join the session by touching either of the respective areas 32, 34.

If the invited user declines, a notification appears to that effect on the host user's phone as shown in FIG. 4, whereon appear a decline text 40. The host user can then select a recognition area 42 to permit a subsequent message from another user to appear, or the host user can choose to invite a replacement user by selecting an invite area 44 on his smart phone 10.

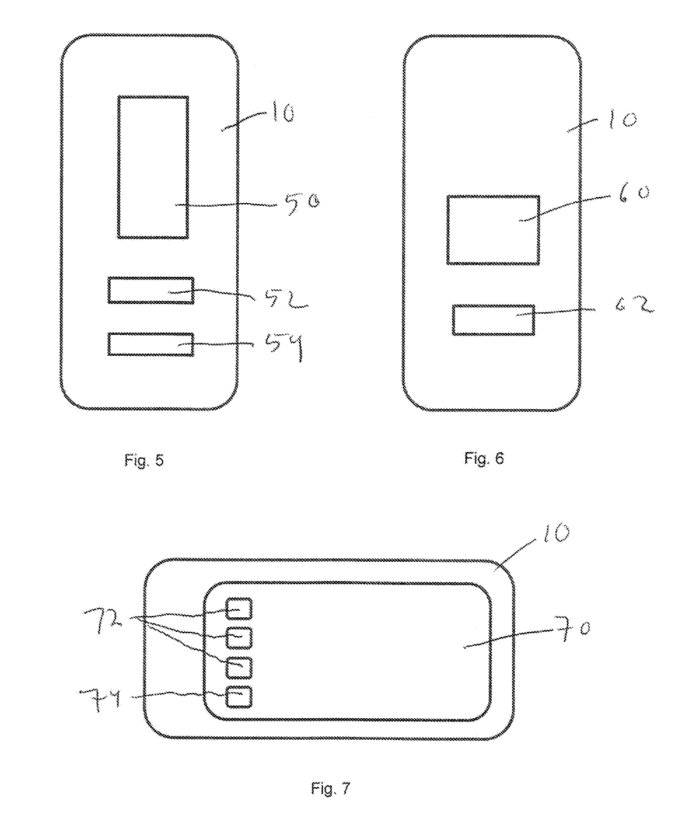

Alternatively, if the invited user accepts, an acceptance text 50 appears on the host user's smart phone 10 as shown in FIG. 5. The host user can then clear the message by selecting a clearing area 52 or view a list of the accepting users by selection a group view area 54 on the smart phone 10.

When the time to begin the session occurs, a notification 60 appears on each of the user's display devices 10, 100 as shown in FIG. 6. Each user can then opt to join the session by selecting a join area 62 on the display device 10, 100.

As shown in FIG. 7, when the session begins, the content appears in a content window 70 on each of the display devices 10, 100. Superimposed on the content window are video icons 72 of each of the invited users, providing real-time images of each as they view the content, as well as video icon 74 of the host user.

Various modifications can be made in the details of the various embodiments of the method of the present invention, all within the scope and spirit of the invention as defined by the appended claims

1. A method for viewing on-line content, the method comprising:
a) providing on-line content on a remote server;
b) selecting on-line content to be viewed on the remote server;
b) selecting a time for viewing the on-line content in a group session;
c) inviting at least one individual to view the on-line content, the at least one individual accepting or rejecting the invitation;
d) providing a notification that the at least one individual has accepted or rejected the invitation;
e) viewing the on-line content beginning at the selected time.

2. The method of claim 1 wherein the on-line content is transcoded for simultaneous streaming.

3. The method of claim 1 further comprising uploading the on-line content to the remote server.

4. The method of claim 1 further comprising maintaining the on-line content in a library on the remote server for a limited time.

5. The method of claim 1 wherein the on-line content is video.

6. The method of claim 1 further comprising providing video chat capability to each of the individuals viewing the on-line content, the video chat capability enabling each of the individuals to communicate with one another.

7. The method of claim 1 wherein the on-line content is selected using an application adapted to communicate with the remote server.

8. The method of claim 1 further comprising creating the on-line content.
